(19) United States
(12) Patent Application Publication
(10) Pub. No.: US 2015/0197312 A1
(43) Pub. Date: Jul. 16, 2015

(54) CLIPLESS PEDAL OF BICYCLE

(71) Applicant: Chin-Long Hsieh, Taichung City (TW)

(72) Inventor: Chin-Long Hsieh, Taichung City (TW)

(21) Appl. No.: 14/154,201

(22) Filed: Jan. 14, 2014

(51) Int. Cl. B62M 3/08

(52) U.S. Cl. CPC B62M 3/086

(57) ABSTRACT

The clipless pedal includes a pedal body, a pedal shaft, a cleat engagement unit, a rear support and an elastic member. The pedal body has a recess at one end thereof. The pedal shaft is rotatably connected to the pedal body. The cleat engagement unit is fastened to the pedal body between the pedal shaft and the recess. The rear support is a U-shaped body and pivoted to the pedal body. The elastic member is clamped between the rear support and an edge of the recess so that the rear support is elastically pushed by the elastic member against the pedal body.

### BACKGROUND OF THE INVENTION

1. Technical Field

This invention generally relates to a bicycle pedal, particularly to a bicycle pedal that is detachably attached to a cleat of a cycling shoe.

2. Related Art

Clipless pedals (also clip-in or step-in) require a special cycling shoe with a cleat fitted to the sole, which locks into a mechanism in the pedal and thus holds the shoe firmly to the pedal. Most clipless pedals lock onto the cleat when stepped on firmly and unlock when the heel is twisted outward, although in some cases the locking mechanism is built into the cleat instead of the pedal.

However, the engagement between the cleat and the pedal is only one point. Although three portions of the sole, which are in the front side and two lateral sides of the cleat, may provide auxiliary support with the pedal, the rear portion of the sole behind the cleat is out of contact with the pedal. Thus the stability of the engagement between the pedal and cleat is insufficient.

### SUMMARY OF THE INVENTION

An objection of the invention is to provide a clipless pedal, which provides auxiliary support to the rear portion of a sole of a cycling shoe.

To accomplish the above objection, the clipless pedal of the invention includes a pedal body, a pedal shaft, a cleat engagement unit, a rear support and an elastic member. The pedal body has a recess at one end thereof. The pedal shaft is rotatably connected to the pedal body. The cleat engagement unit is fastened to the pedal body between the pedal shaft and the recess. The rear support is a U-shaped body and pivoted to the pedal body. The elastic member is clamped between the rear support and an edge of the recess so that the rear support is elastically pushed by the elastic member against the pedal body.

To accomplish the above objection, the clipless pedal of the invention includes a pedal body, a pedal shaft, a cleat engagement unit and a rear support. The pedal body has a first side and a second side. The pedal shaft is rotatably connected to the pedal body. The cleat engagement unit is fastened onto the first side of the pedal body. The rear support is a U-shaped elastic sheet has a fixed end and a free end. The fixed end is fastened onto the second side of the pedal body, and the free end extends toward the first side.

### BRIEF DESCRIPTION OF THE DRAWINGS

FIG. 1 is a perspective view of the first embodiment of the invention;

FIG. 2 is an exploded view of the first embodiment of the invention;

FIG. 3 is a sectional view of the first embodiment of the invention;

FIG. 4 is a schematic view of the first embodiment of the invention in use;

FIG. 5 is a perspective view of the first embodiment with an asymmetrical arrangement;

FIG. 6 is a perspective view of the second embodiment of the invention;

FIG. 7 is an exploded view of the second embodiment of the invention;

FIG. 8 is a sectional view of the second embodiment of the invention;

FIG. 9 is a perspective view of the second embodiment with an asymmetrical arrangement;

FIG. 10 is a perspective view of the third embodiment of the invention;

FIG. 11 is an exploded view of the third embodiment of the invention;

FIG. 12 is a sectional view of the third embodiment of the invention;

FIG. 13 is a schematic view of the third embodiment of the invention in use;

FIG. 14 is an exploded view of the third embodiment with an asymmetrical arrangement;

FIG. 15 is another exploded view of the embodiment of FIG. 13; and

FIG. 16 is a perspective view of the embodiment of FIG. 13.

### DETAILED DESCRIPTION OF THE INVENTION

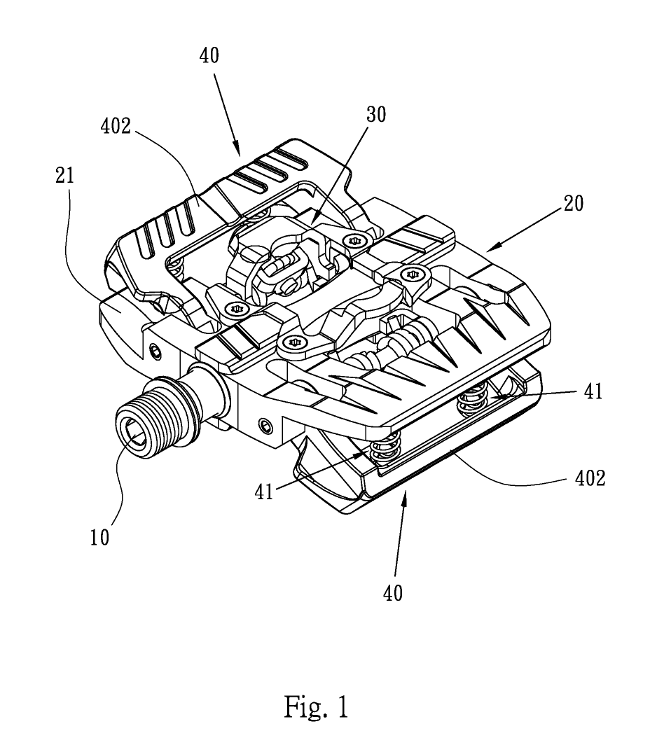

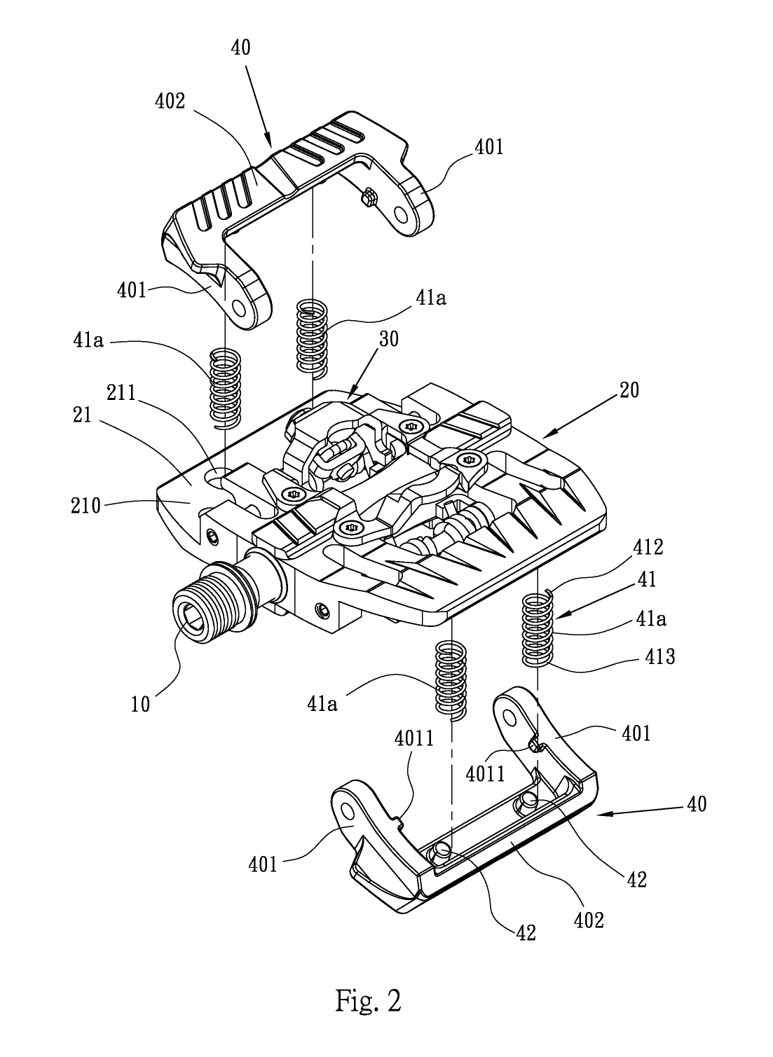

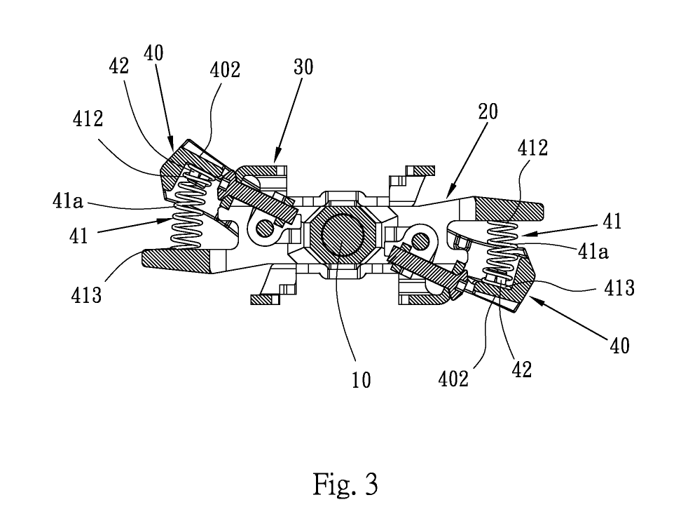

Please refer to FIGS. 1-3, which show the first embodiment of the pedal of the invention. This embodiment is of a symmetrical arrangement, which means two opposite sides of the pedal are provided with the same mechanism and can be used without discernment.

As shown, the clipless pedal includes a pedal body 20, a pedal shaft 10, two cleat engagement units 30, two rear supports 40 and two pair of elastic members 41, wherein one cleat engagement units 30, one rear supports 40 and a pair of elastic members 41a compose an independent assembly and the pedal body 20 is disposed with two identical assemblies which are symmetrically arranged on two opposite sides of the pedal body 20.

The pedal body 20 has two recesses 21 at two opposite ends thereof. The pedal shaft 10 is rotatably connected to the pedal body 20. Each of the cleat engagement units is fastened to the pedal body 20 between the pedal shaft 10 and the recess 21. The rear support 40 is a U-shaped body composed of two legs 401 and a bridge 402. Each of the legs 401 is formed with a pivot 4011 connected to the pedal body 20 so that the rear support 40 can be swayed against the pedal body 20.

In this embodiment, each of the elastic members 41 is composed of two compression springs 41a. Of course, one compression spring is also available. The compression springs 41a are clamped between the rear support 40 and an edge 210 of the recess 21 so that the rear support 40 can be normally elastically pushed by the compression springs 41a against the pedal body 20. The compression spring 41a has a first end 412 touching the rear support 40 and a second end 413 touching the pedal body 20.

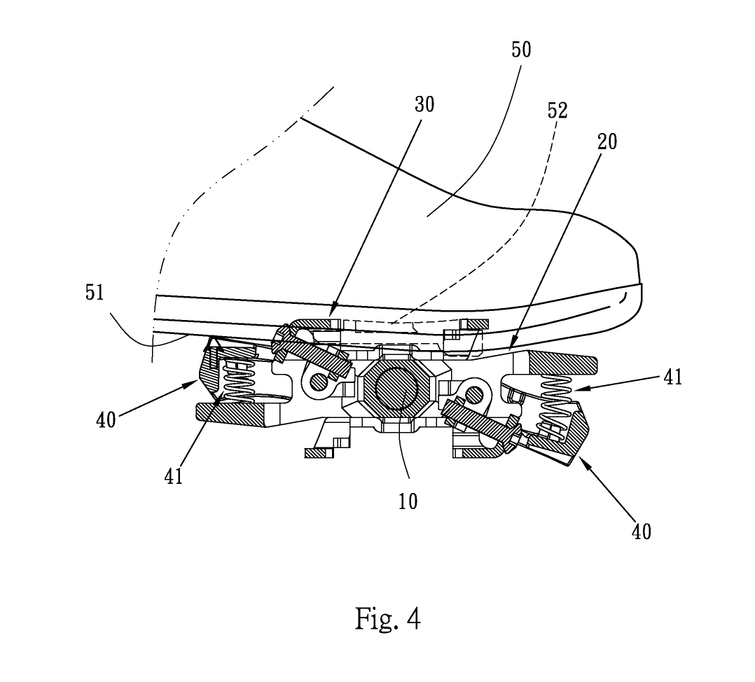

Please refer to FIG. 4. When a cleat 52 on a sole 51 of a shoe 50 engages with the cleat engagement unit 30, the rear portion of the sole 51 will be elastically pushed by the rear support 40. This will enhance the stability of the engagement between the shoe 50 and the pedal.

Furthermore, the inside of the bridge 402 of the rear support 40 is formed with two protrusions 42 corresponding to the compression springs 41a. The protrusions 42 are separately inserted into the first ends of the compression springs 41a. The edge 210 of the recess 21 is further formed with two receiving holes 211 for separately receiving the second ends 413 of the compression springs 41a. The protrusions 42 and receiving holes 211 can firmly hold the compression springs 41a without unexpectedly moving.

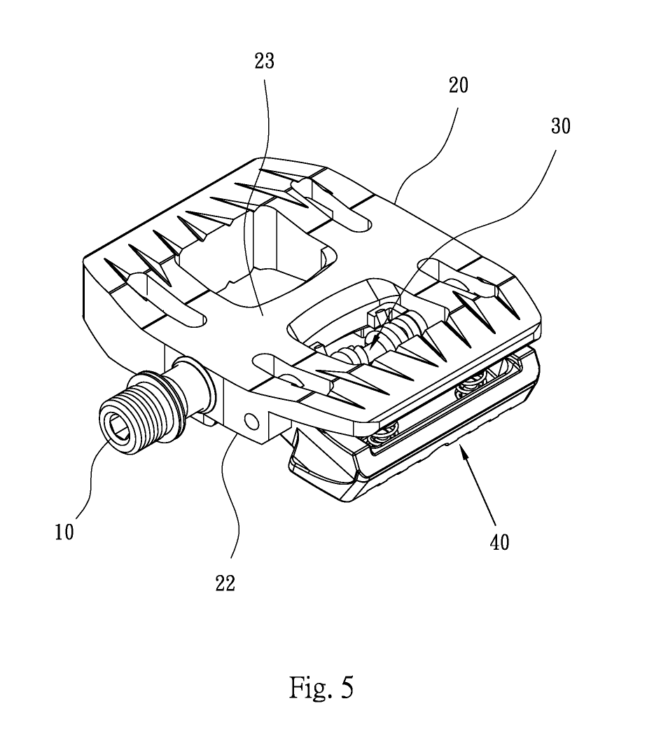

FIG. 5 shows the first embodiment with an asymmetrically arrangement, which means only one rear support 40 is provided. The pedal body 20 has a first side 22 and a second side 23. The cleat engagement unit 30 and the rear support 40 are disposed only on the first side 22 and the second side 23 forms a normal pedal.

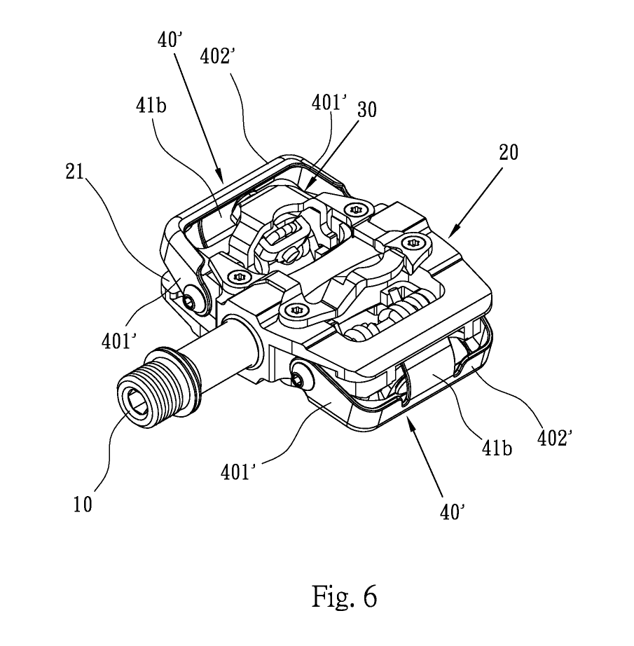

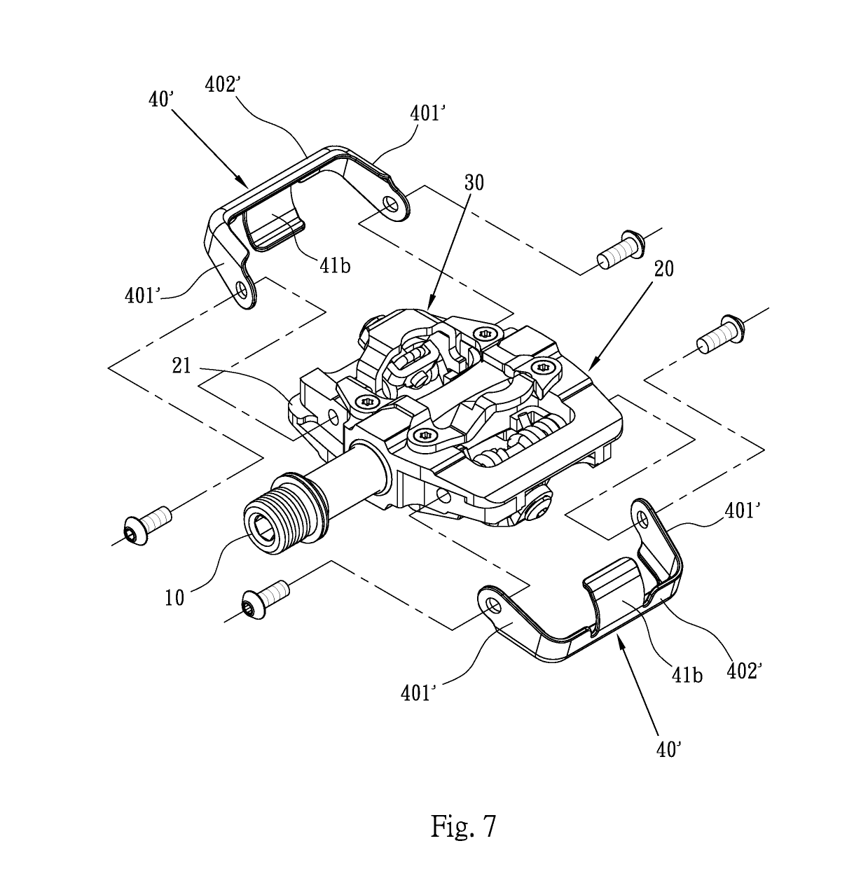

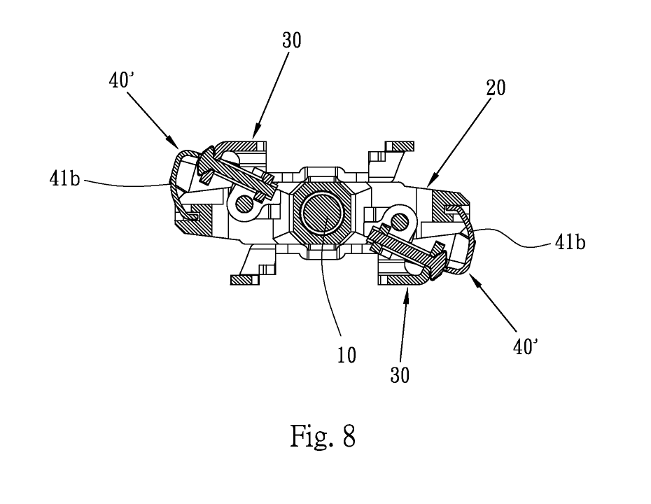

Please refer to FIGS. 6-8, which show the second embodiment of the invention. The second embodiment differs from the first embodiment by the elastic member and the rear support 40′. In the second embodiment, the elastic member is an elastic sheet 41b integratedly extending from the rear support 40′. The rear support 40′ is also of a U-shape composed of a bridge 402′ and two legs 401′. The elastic sheet 41b is extended from the bridge 402′. The elastic sheet 41b is an arched tongue toward the pedal shaft 10.

The two legs 401′ of the rear support 40′ are fixed to the pedal body 20 by screws and cannot sway. Like the first embodiment, the elastic sheet 41b will be pressed by a sole of a shoe and will provide elastically support to the shoe.

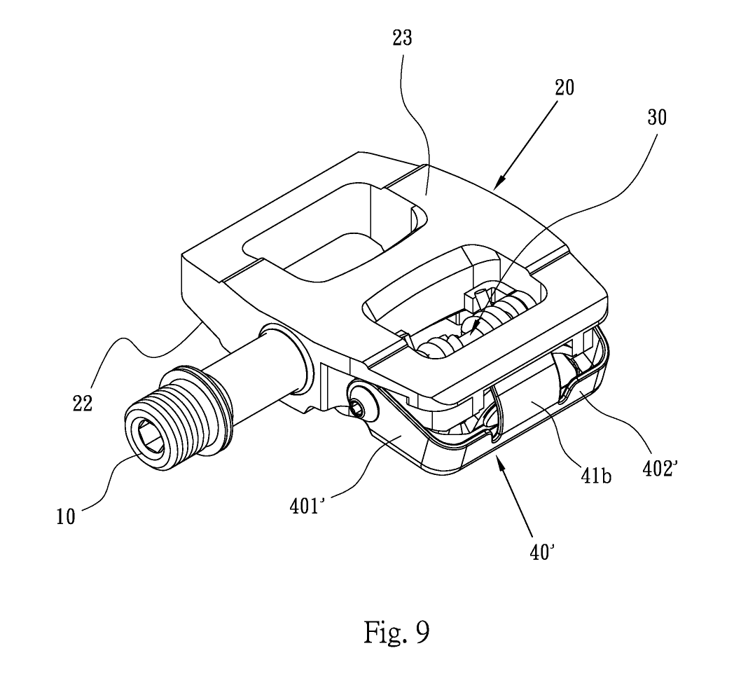

Similar to FIG. 5, the second embodiment can also be provided with an asymmetrically arrangement. As shown in FIG. 9, the pedal body 20 has a first side 22 and a second side 23. The cleat engagement unit 30 and the rear support 40′ are disposed only on the first side 22 and the second side 23 forms a normal pedal.

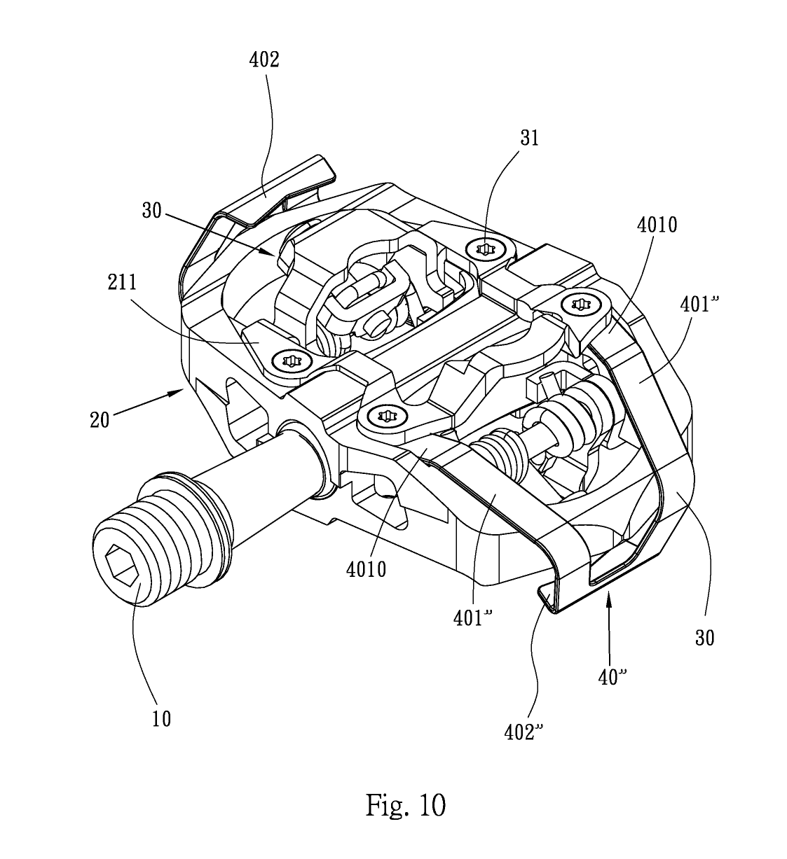

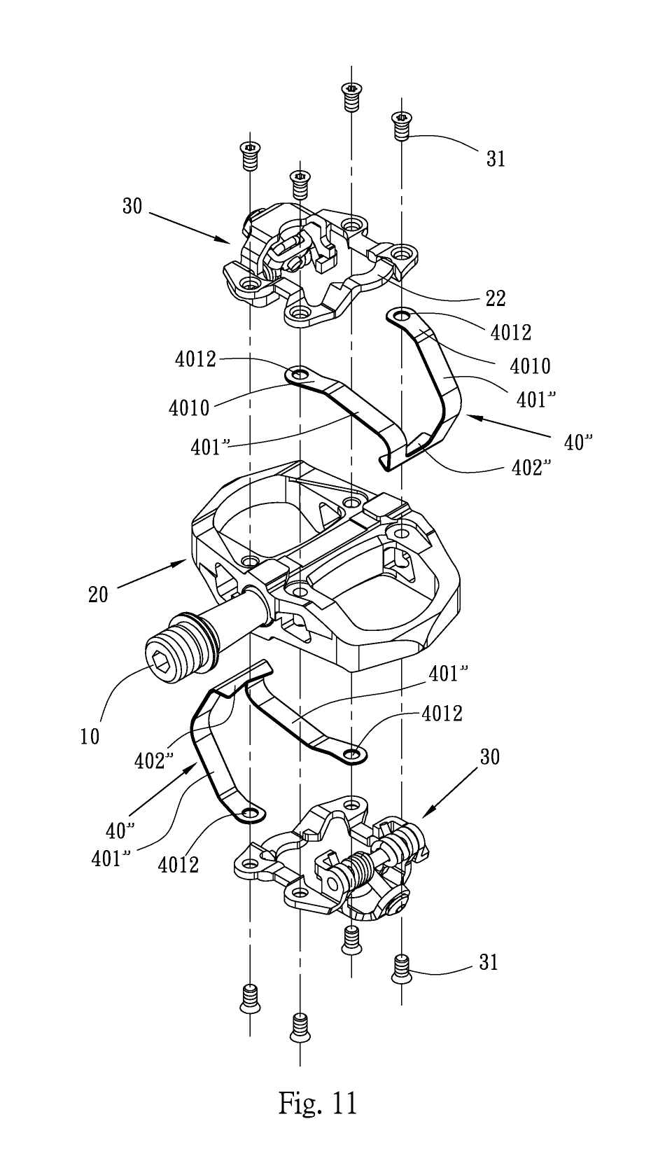

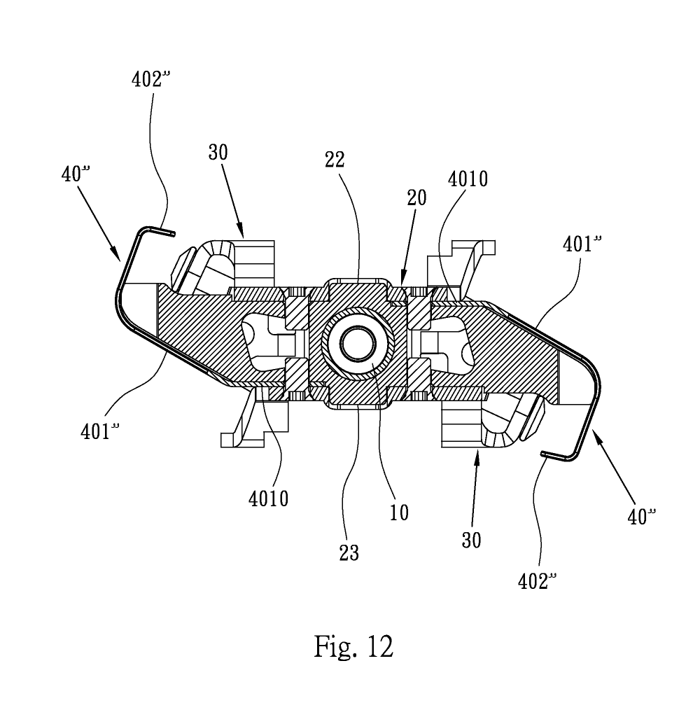

FIGS. 10-12 show a third embodiment of the invention. In this embodiment, the cleat engagement units 30 are separately fastened onto the first and second sides 22, 23 of the pedal body 20 by screws 31.

The rear support 40″ is a U-shaped elastic sheet composed of two legs 401″ and a bridge 402″. Two ends of the legs form two fixed ends 4010, and the bridge 402″ forms a free end. The fixed ends 4010 are separately provided with two fixing holes 4012 and are fastened onto one side of the pedal body 20 (i.e., the first side 22 or the second side 23) by screws 31. Preferably, some of the screws are commonly used to fix the cleat engagement unit 30 and the rear support 40″. The legs 401″ and the bridge 402″ are arched, and the free end extends toward the other side of the pedal body 20 (i.e., the second side 23 or the first side 22).

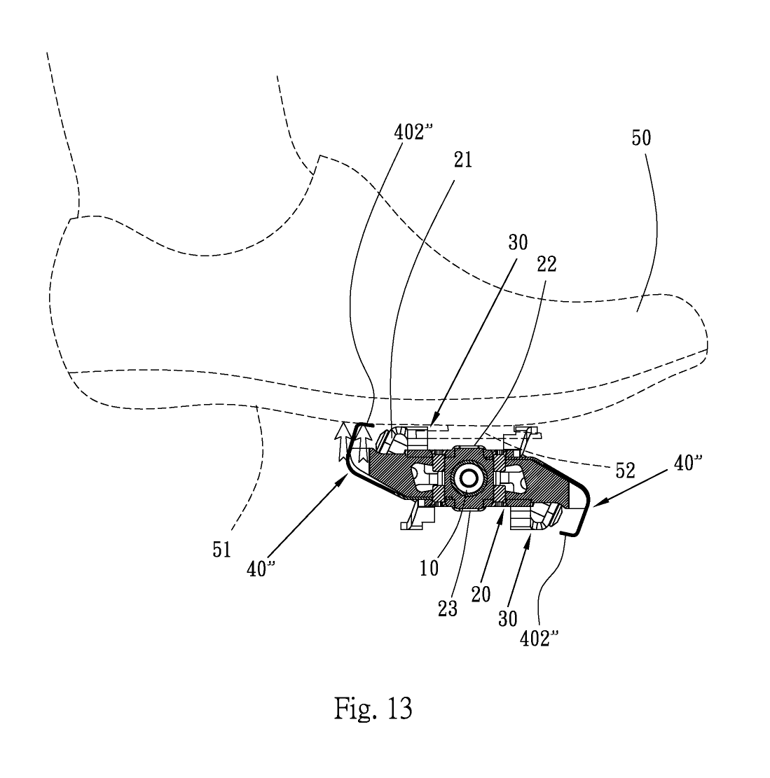

Please refer to FIG. 13. When a cleat 52 on a sole 51 of a shoe 50 engages with the cleat engagement unit 30, the rear portion of the sole 51 will be elastically pushed by the rear support 40″. This will enhance the stability of the engagement between the shoe 50 and the pedal.

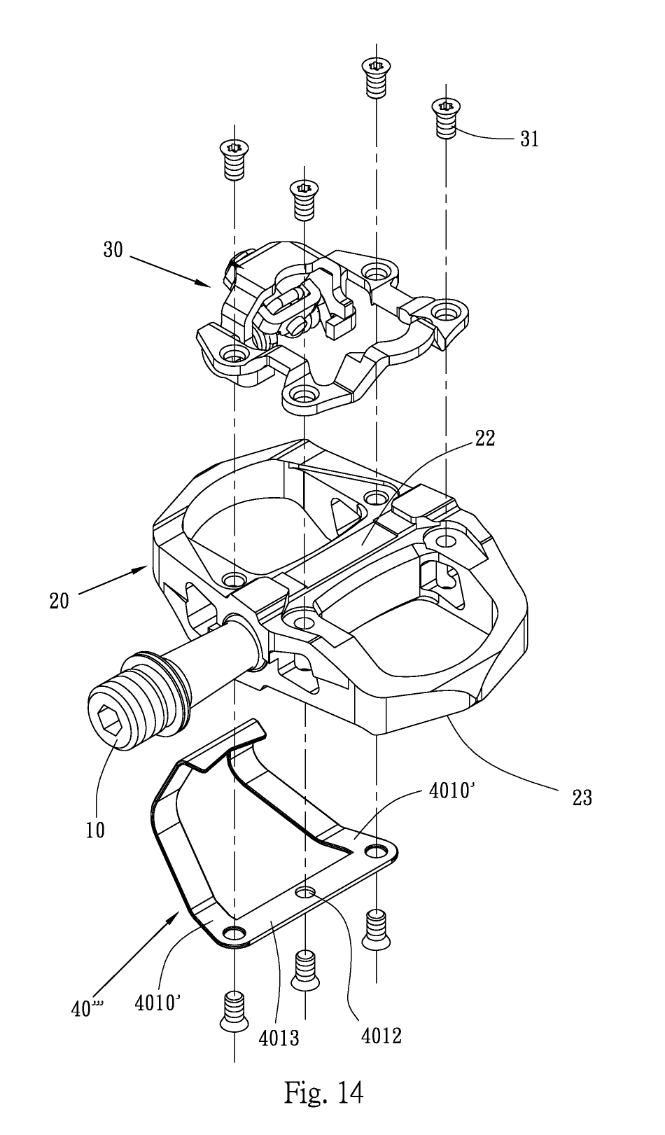

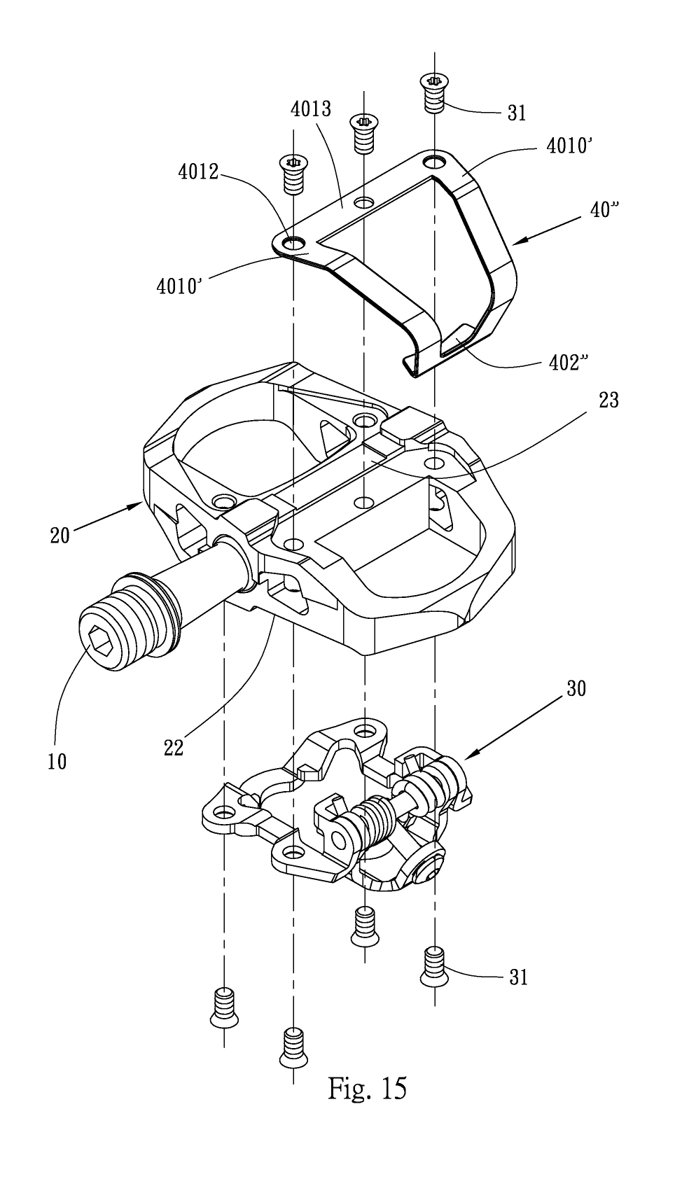

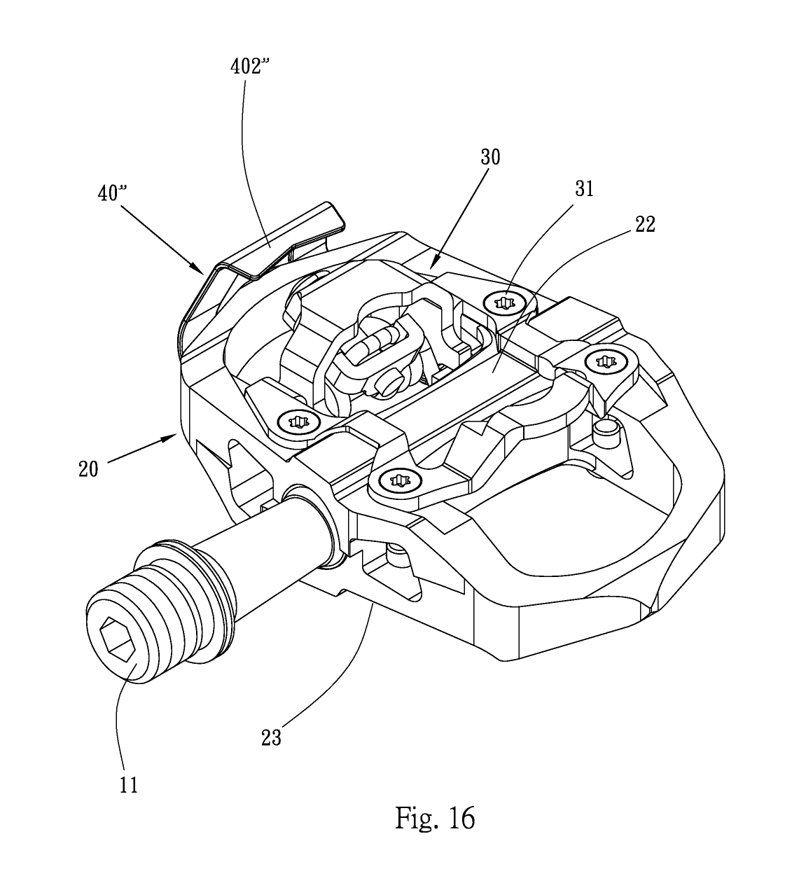

FIGS. 14-16 show the third embodiment with an asymmetrically arrangement, which means only one rear support 40″ is provided. The cleat engagement unit 30 is fixed only on the first side 22 and the rear support 40″ is fixed only on the second side 23. In this embodiment, the fixed ends 4010′ of the rear support 40′″ are connected with a bar 4013.

It will be appreciated by persons skilled in the art that the above embodiments have been described by way of examples only and not in any limitative sense, and that various alterations and modifications are possible without departure from the scope of the invention as defined by the appended claims.

What is claimed is:

1. A clipless pedal of a bicycle, comprising:
a pedal body, having a recess at one end thereof;
a pedal shaft, rotatably connected to the pedal body;
a cleat engagement unit, fastened to the pedal body between the pedal shaft and the recess;
a rear support, being a U-shaped body, and connected to the pedal body;
an elastic member, clamped between the rear support and an edge of the recess so that the rear support is elastically pushed by the elastic member against the pedal body.

2. The clipless pedal of claim 1, wherein rear support is immovably fixed to the pedal body, and the elastic member is an elastic sheet integratedly extending from the rear support.

3. The clipless pedal of claim 1, wherein the rear support is immovably fixed to the pedal body, and the elastic member is at least one compression spring.

4. The clipless pedal of claim 3, wherein the at least one elastic member has a first end touching the rear support and a second end touching the pedal body.

5. The clipless pedal of claim 4, wherein the rear support is formed with a protrusion inserted into the first end of the elastic member, and the edge of the recess is formed with a receiving hole receiving the second end of the elastic member.

6. A clipless pedal of a bicycle, comprising:
a pedal body, having a first side and a second side;
a pedal shaft, rotatably connected to the pedal body;
a cleat engagement unit, fastened onto the first side of the pedal body;
a rear support, being a U-shaped elastic sheet composed of two legs and a bridge, two ends of the legs forming two fixed ends, the bridge forming a free end, wherein the fixed ends are fastened onto the second side of the pedal body, the legs and the bridge are arched, and the free end extends toward the first side.

7. The clipless pedal of claim 6, wherein the fixed ends are separately provided with two fixing holes.

8. The clipless pedal of claim 6, wherein the fixed ends of the rear support are connected with a bar.
